(19) United States
(12) Patent Application Publication
(10) Pub. No.: US 2008/0075939 A1
(43) Pub. Date: Mar. 27, 2008

(54) METHOD FOR PREPARING LAYERED NANOSTRUCTURES AND LAYERED NANOSTRUCTURES PREPARED THEREBY

(75) Inventors: Ho Young KWAK, Seoul (KR); Il Wun SHIM, Seoul (KR); Ki Taek BYUN, Seoul (KR); Seung Soo LEE, Seoul (KR)

Correspondence Address: CANTOR COLBURN, LLP, 20 Church Street, 22nd Floor, Hartford, CT, 06103, US

(73) Assignees: SAMSUNG ELECTRONICS CO., LTD., Suwon-si (KR); SEOUL NATIONAL UNIVERSITY INDUSTRY FOUNDATION, Seoul (KR); CHUNG-ANG UNIVERSITY INDUSTRY-ACADEMY CORPORATION FOUNDATION, Seoul (KR)

(21) Appl. No.: 11/835,343

(22) Filed: Aug. 7, 2007

(30) Foreign Application Priority Data
Sep. 25, 2006 (KR) 10-2006-0092837
Jun. 21, 2007 (KR) 10-2007-0061142

(51) Int. Cl. B32B 7/02; B06B 1/00; B32B 9/04

(52) U.S. Cl. 428/216; 427/600; 428/411.1

(57) ABSTRACT

Disclosed are a method for preparing layered nanostructures by coating a nanomaterial on a nano-scale support under multibubble sonoluminescence conditions and layered nanostructures prepared by the method. The method is capable of uniformly coating a nanomaterial to a desired thickness on a nano-scale support.

### PRIORITY STATEMENT

This non-provisional application claims priority under 35 U.S.C. §119 to Korean Patent Application No. 10-2007-0061142, filed on Jun. 21, 2007 and Korean Patent Application No. 10-2006-0092837, filed on Sep. 25, 2006 in the Korean Intellectual Property Office (KIPO), the entire contents of which are incorporated herein by reference.

### BACKGROUND

1. Field

Example embodiments include a method for preparing layered nanostructures and layered nanostructures prepared by the method. Other example embodiments include a method for preparing layered nanostructures that is capable of uniformly coating a nanomaterial to a desired thickness on a nano-scale support under multibubble sonoluminescence conditions and layered nanostructures prepared by the method.

2. Description of the Related Art

In recent years, a large number of nano-scale semiconductor materials have been researched for a variety of applications in magneto-optical memory devices, optical sensors and photocatalysts. Intense interest in fabrication of nano-scale semiconductor materials is well-known through a variety of research results. A great deal of researches associated with fabrication of nano-scale semiconductor materials focus on controlling the size of semiconductor materials and coating other active nanomaterials on the surfaces of grown nano-scale materials.

Various methods for preparing nanoparticles were reported. For example, wet chemical synthesis, surfactant-mediated techniques, vapor phase growth, microwave-mediated techniques, etc have been known in the art.

Nanoparticles prepared by these methods are controlled over a size not larger than 100 nm and are thus utilized in photocatalysts, optical sensors, etc. The methods have advantages of low preparation costs and simple preparation equipment, but have drawbacks on the necessities of high-temperature heat, high pressure and additives besides reactants in preparation processes, and long preparation time. In particular, to date, there is no research result associated with coating another nanomaterial on a nanosupport.

At present, various methods for coating nanoparticles on support-nanoparticles are known. For example, simple ultrasonic tests [Suslick, K. S. Science 1990, 247, 1439.], microwave-mediated tests [Yitai Qian et al, Materials Chemistry and Physics 78 (2002) 288-291], chemical bath deposition [V. P. Singh et al, Solar Energy Materials & Solar Cells 81 (2004) 293-303], etc. were reported.

Of these methods, however, the microwave-mediated method has disadvantages in that a nanomaterial is non-uniformly coated on the surface of a nanosupport and surrounds the nanosupport surface in the form of quantum dots. The chemical bath deposition has a disadvantage of difficulty in adjusting the thickness of the nanomaterial coated to a desired level.

Of these methods, simple ultrasonic tests are known as the most typical method for preparing a pure single nanosupport. The simple ultrasonic tests are attempted both to prepare a single nanomaterial and to coat another nanomaterial on the single nanomaterial. However, such a method has also disadvantages in that the nanomaterial is prepared in the only manner such that it surrounds the surface of the nanosupport in the form of quantum dots, and in that the preparation is necessarily carried out at a high temperature using an inert gas (N. Arul Dhas and A. Gedanken, APPLIED PHYSICS LETTERS, 1998, 72, 2514˜2516).

Accordingly, a demand to develop efficient methods that are capable of uniformly coating another nanomaterial on the surface of a nanosupport still remains in the art.

### SUMMARY

Example embodiments provide a method for preparing layered nanostructures that is capable of uniformly coating a nanomaterial to a desired thickness on the surface of a nano-scale support.

Example embodiments provide layered nanostructures prepared by the method.

In accordance with example embodiments, there is provided a method for preparing layered nanostructures by coating a nanomaterial on a nano-scale support under multibubble sonoluminescence conditions.

In accordance with example embodiments, there is provided layered nanostructures prepared by the method, the layered nanostructures having a structure where a nanomaterial is coated on a nano-scale support.

### BRIEF DESCRIPTION OF THE DRAWINGS

Example embodiments will be more clearly understood from the following detailed description taken in conjunction with the accompanying drawings. FIGS. 1-8 represent non-limiting, example embodiments as described herein.

FIG. 1 is XRD patterns of layered nanoparticles prepared in Example 1;

FIG. 2 is XRD patterns of layered nanoparticles prepared in Example 2;

FIG. 3 is XRD patterns of layered nanoparticles prepared in Example 3;

FIG. 4 is a TEM image of bare TiO₂ nanoparticles;

FIG. 5 is a TEM image of layered nanoparticles prepared in Example 1;

FIG. 6 is a HR-TEM image of layered nanoparticles prepared in Example 1;

FIG. 7 is a HR-TEM image of layered nanoparticles prepared in Example 2; and

FIG. 8 is a HR-TEM image of layered nanoparticles prepared in Example 3.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DESCRIPTION OF EXAMPLE EMBODIMENTS

Example embodiments will now be described in greater detail with reference to the accompanying drawings. In the drawings, the thicknesses and widths of layers are exaggerated for clarity. Example embodiments may, however, be embodied in many different forms and should not be construed as limited to the example embodiments set forth herein. Rather, these example embodiments are provided so that this disclosure will be thorough and complete, and will fully convey the scope of example embodiments to those skilled in the art.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context: clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “layered nanostructure” describes a nanostructure that has a layered structure where a nanomaterial is uniformly coated on the surface of a nanostructure as a nano-scale support. The shape of the nanostructure as a nano-scale support is not particularly limited in the present invention and examples thereof include nanoparticles and nanowires.

Example embodiments are directed to a method for preparing layered nanostructures by uniformly coating a nanomaterial on a nanostructure under multibubble sonoluminescence conditions.

Multibubble sonoluminescence is one of practical applications of sonoluminescence and is designed to substantially simultaneously generate a great deal of bubbles by irradiation of high-energy sonic waves and emit light upon growth and collapse of the bubbles.

Multibubble sonoluminescence spectra consist of continuous parts and peaks. The peaks are believed to be caused by electron transition of solvent molecules contained in bubbles. In addition, upon collapse of bubbles, a high-temperature (i.e. about 1,000° C.) high-pressure (i.e. about 500 bar) liquid zone is formed around the bubble walls on which multibubble sonoluminescence occurs, and hydroxyl (—OH) groups are produced in the liquid zone. Owing to high reactivity, the hydroxyl groups oxidize organic metals and involve high-energy chemical reactions which decompose contaminants in water. Sonochemical reactions under multibubble sonoluminescence conditions have advantages of rapid reaction time and efficient production of desired materials, as compared to sonochemical reactions under simple ultrasonic waves.

The nano-scale support is not particularly limited in example embodiments, but may be selected from metal oxide particles with a diameter of 50 nm or less. Examples of the metal oxide particles include, but are not limited to TiO₂, ZnO, ZrO, Al₂O₃Fe₂O₃, Fe₃O₄, Ga₂O₃, SnO₂, Sb₂O₃, SiO₂, MnO₂, NiO₂ and mixtures thereof.

The nanomaterial coated on the nano-scale support is not particularly limited, but may be selected from metal chalcogenide including metal sulfide, metal selenide and metal telluride. Examples of the metal chalcogenide include, but are not limited to CdS, ZnS, HgS, PbS, InS, AgS, CuS, CdSe, ZnSe, HgSe, PbSe, InSe, AgSe, CuSe, CdTe, ZnTe, HgTe, PbTe, InTe, AgTe, CuTe and a mixture thereof.

In example embodiments of the present invention, the multibubble sonoluminescence conditions used to prepare the layered nanostructure are defined as a state in which a pressure of 1 to 2 atm is maintained via introduction of an inert gas into a reactor and a constant temperature of 20 to 70° C. is kept, within ultrasonic frequency and power bands at which multibubble sonoluminescence occurs.

The multibubble sonoluminescence used in the present invention employs sonoluminescence which is a light emission phenomenon upon collapse of ultra-fine (˜10 μm) bubbles oscillating at a ultrasonic wavelength, while taking into consideration the fact that when bubbles inside a solvent are oscillated by ultrasonic wave, the sonoluminescence is stably maintained even under an inner pressure (1 to 2 atm) of the solvent. The reactor inner pressure is 1 to 2 atm, more preferably, 1.40 to 1.45 atm.

Under the multibubble sonoluminescence conditions, metal chloride, a chalcogen element precursor and metal oxide are mixed with a solvent in the reactor, and metal chalcogenide is uniformly in-situ coated on metal oxide as a nano-scale support, to obtain a layered nanostructure. Of the metal chloride, the chalcogen element precursor and the metal oxide which are mixed with the solvent in the reactor, the metal oxide (the nano-scale support) is insoluble in the solvent, but the metal chloride and the chalcogen element precursor are ionized when an ultrasonic wave is applied, and are then reacted with each other to produce metal chalcogenide. The ultrasonic wave applied induces the reaction, allowing the metal chalcogenide to be coated on the surface of the metal oxide.

The ultrasonic frequency and power bands, at which multibubble sonoluminescence occurs, are in the range of 10 to 20 khz and 100 to 220 W, respectively. The reactor is not particularly limited in the present invention, but may be a glass or quartz reactor. Examples of the inert gas that may be used herein include, but are not limited to argon, nitrogen and helium gases. The reaction may be carried out at room temperature, preferably, at 20 to 70° C.

As the solvent, distilled water, alcohol or the like may be used herein, but the use of a highly volatile solvent such as methylene chloride, acetone or the like is not preferable.

During the coating under the multibubble sonoluminescence conditions, the ultrasonic wave reaction is preferably carried out for 20 to 30 min. When the ultrasonic wave reaction time is shorter than 20 min, the metal chalcogenide is incompletely produced. For this reason, the metal chalcogenide is not sufficiently coated on the metal oxide surface and the size of the nanostructure formed is non-uniform. On the other hand, the ultrasonic wave reaction time longer than 20 min is undesirable in that the coating is peeled away or the reaction has been already completed.

In the preparation method of the layered nanostructure employing multibubble sonoluminescence of the present invention, the thickness of the nanomaterial coated on the nano-scale support finally produced depends on a concentration ratio between initial reactants. As a result, the thickness of the layered nanostructure can be adjusted to a desired level.

According to example embodiments of the present invention, the metal chloride and the chalcogen element precursor as initial reactants are mixed in a mole ratio of 1:1. Examples of the metal chloride include cadmium chloride, zinc chloride, mercury chloride and the like. Examples of the chalcogen element precursor include thioacetamide, sodium sulfide, dithiocarbamate, sodium thiosulfate, diselenoacetamide, sodium selenide, diselenocarbamate and sodium selenate.

At this time, the metal chloride and the chalcogen element precursor as initial reactants are in situ reacted under multibubble sonoluminescence conditions to produce metal chalcogenide with a composition ratio of 1:1, and examples of the metal chalcogenide include CdS, ZnS, HgS, PbS, InS, AgS, CuS, CdSe, ZnSe, HgSe, PbSe, InSe, AgSe, CuSe, CdTe, ZnTe, HgTe, PbTe, InTe, AgTe and CuTe. Then, layered nanoparticles, where the metal chacogenide is coated on the metal oxide surface, are obtained as final products.

Since the reaction concentration ratio of the metal oxide to the metal chalcogenide is in a range of 3:1 to 5:1, the finally-coated thickness ratio of the metal chalcogenide:the metal oxide is adjusted to the range of 1:10 to 1:5.

According to example embodiments of the present invention, in preparation of layered nanoparticles, where the metal chalcogenide are coated on the metal oxide surface, when the reaction concentration ratio of the metal oxide to the metal chalcogenide is lower than 3:1, the metal chalcogenide is coated to an excessively thin thickness smaller than 2 nm on the metal oxide surface. On the other hand, when the reaction concentration ratio exceeds 5:1, a relatively large amount of the metal chalcogenide is produced. As a result, there is a risk that metal chalcogenide is uncoated on the metal oxide and these two materials are thus present in the form of particles.

Accordingly, since the metal chloride is in situ mixed with the chalcogen element precursor in a reaction mole ratio of 1:1 and the metal chalcogenide and the metal oxide are mixed in a reaction concentration ratio of 3:1 to 5:1, the coated thickness ratio of the metal chalcogenide:the metal oxide can be adjusted to the range of 1:10 to 1:5.

According to the method of example embodiments, it is possible to reproductively prepare a pure layered nanostructure where a nanomaterial is uniformly coated to a desired thickness on the surface of a nano-support.

Example embodiments of the present invention are directed to a layered nanostructure prepared by the method, the layered nanostructure having a structure in which a nanomaterial is coated on a nano-support.

In other example embodiments, the nano-scale support is not particularly limited, but may be selected from metal oxide with a size of 50 nm or less. Examples of the metal oxide include, but are not particularly limited to TiO₂, ZnO, ZrO, Al₂O₃, Fe₂O₃, Fe₃O₄, Ga₂O₃, SnO₂, Sb₂O₃, SiO₂, MnO₂, NiO₂ and a mixture thereof.

The nanomaterial coated on the nano-scale support is not particularly limited, but may be selected from metal chalcogenide including metal sulfide, metal selenide and metal telluride. Examples of the metal chalcogenide include, but are not limited to CdS, ZnS, HgS, PbS, InS, AgS, CuS, CdSe, ZnSe, HgSe, PbSe, InSe, AgSe, CuSe, CdTe, ZnTe, HgTe, PbTe, InTe, AgTe, CuTe and mixtures thereof.

Any nano-scale support may be used without particular limitation so long as it has a nano-scale diameter. The nanomaterial is coated to a thickness of 2 to 30 nm on the nano-scale support.

Other example embodiments of the present invention are directed to layered nanoparticles, in which metal chalcogenide is coated on the surface of metal oxide. It is undesirable that the thickness of the metal chalcogenide in layered nanoparticles exceeds 30 nm, since the metal chalcogenide is excessively clustered and is thus not coated on the metal oxide surface.

Hereinafter, example embodiments will be explained in more detail with reference to the following examples. However, these examples are given for the purpose of illustration and are not to be construed as limiting the scope of example embodiments.

### EXAMPLES

### Example 1

Distilled water was prepared as a solvent in a glass container of an ultrasonic generator, and cadmium chloride of 6.3 mmol, thioacetamide of 6.3 mmol and TiO₂ (1.25 mmol, diameter: 20 nm) were added thereto. The mixture was reacted with each other with ultrasonic irradiation. At this time, an ultrasonic frequency and an ultrasonic power were 20 kHz and 220 W, respectively, an argon (Ar) gas was introduced into the glass container and a constant temperature reactor was maintained at a temperature of 50° C., to secure multibubble sonoluminescence conditions. Then, ultrasonic irradiation was carried out for 20 min. The resulting product was separated using a centrifuge, recrystallized, dried at room temperature and dried in a dry oven for about 10 hours, to prepare layered-nanoparticles where CdS was uniformly coated to a thickness of 25 to 30 nm on the surface of TiO₂ (hereinafter, referred to as “CdS-coated TiO₂ nanoparticles”).

### Example 2

Layered nanoparticles were prepared where ZnS was uniformly coated to a thickness of 2 nm on the surface of TiO₂ (hereinafter, referred to as “ZnS-coated TiO₂ nanoparticles”) in the same manner as in Example 1, except that zinc chloride of 3.75 mmol was used instead of cadmium chloride. Then, the nanoparticles were washed several times with a solvent such as distilled water, ethanol or acetone without using any centrifuge and were then recrystallized.

### Example 3

Layered nanoparticles were prepared where HgS was uniformly coated to a thickness of 2 nm on the surface of TiO₂ (hereinafter, referred to as “HgS-coated TiO₂ nanoparticles”) in the same manner as in Example 1, except that mercury chloride of 3.75 mmol was used instead of cadmium chloride and thioacetamide was used in an amount of 3.75 mmol. Then, the nanoparticles were washed several times with a solvent such as distilled water, ethanol or acetone without using any centrifuge and were thus recrystallized.

### Example 4

Layered nanoparticles we re prepared where CdS was uniformly coated to a thickness of 2 nm on the surface of TiO₂ in the same manner as in Example 1, except that cadmium chloride was used in an amount of 3.75 mmol.

### Experimental Example 1

### Analysis of Thin Film Properties

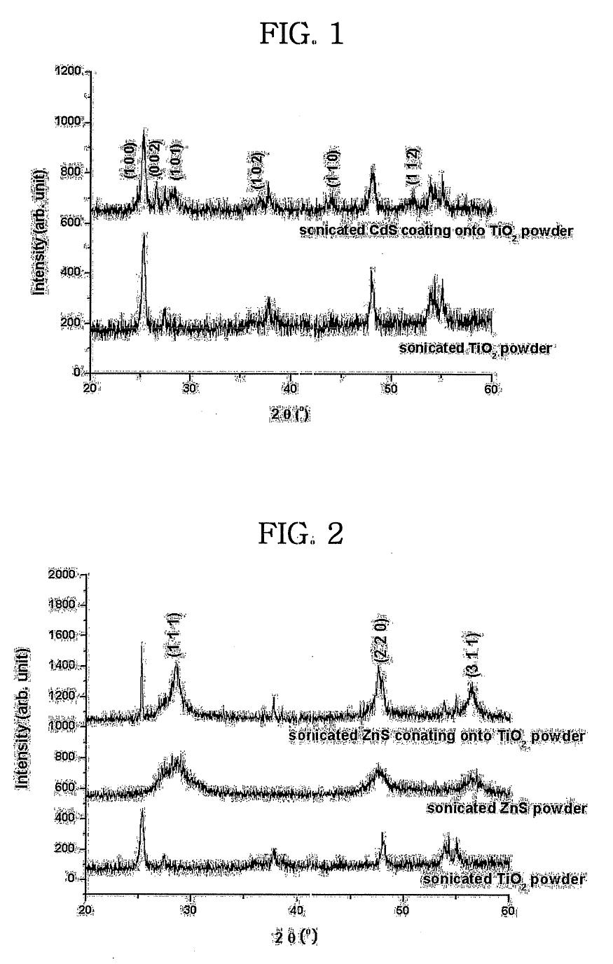

With respect to the layered nanoparticles prepared in Examples 1 to 3, the structures of thin films were observed using an X-ray diffractometer (XRD, Scintag XDS-2000). FIG. 1 shows XRD patterns of the CdS-coated TiO₂ nanoparticles prepared in Example 1. As can be seen from the XRD patterns in FIG. 1, the CdS-coated TiO₂ nanoparticles are in a hexagonal phase with the peaks at 2θ=24.8°, 26.4°, 28.2°, 36.6°, 43.7° and 51.9° (JCPDS 1995 No. 06-0314). These results indicate that since CdS particles prepared at 450° C. are typically in cubic phase, the multibubble sonoluminescence in Example 1 is carried out under the conditions that the temperature of the liquid zone around bubble walls formed during the bubble collapse is actually higher than 450° C.

The positions, at which the peaks of the CdS-coated TiO₂ nanoparticles are plotted, are identical to the cases of nano-scale CdS and TiO₂ alone. The peak thicknesses of the CdS-coated TiO₂ nanoparticles were observed to be larger than those of the CdS and TiO₂. That is, the relatively low intensities of peaks are assumed to arise from the fact that the particles are nano-scaled and the CdS is thinly coated on the surface of TiO₂.

In addition, energy dispersive X-ray (EDX) spectroscopy analyses reveal that the atomic percents of Cd, S and Ti are 12.19%, 14.43%, and 72.09%, respectively. It was confirmed from this result that the composition ratio of Cd/S was nearly 1:1, the nanoparticles were prepared according to a reaction concentration ratio of CdS:TiO₂=5:1 and the thickness ratio of CdS/TiO₂ was 1:5.

FIG. 2 shows XRD patterns of the ZnS-coated TiO₂ nanoparticles prepared in Example 2. The XRD patterns indicate that ZnS is in a tetragonal phase (JCPDS 1995 No. 05-0566). The positions, at which the peaks of the ZnS-coated TiO₂ nanoparticles prepared under the multibubble sonoluminescence conditions are plotted, are identical to the cases of ZnS and TiO₂ prior to coating. The peak thicknesses of the ZnS-coated TiO₂ nanoparticles were observed to be larger than those of the CdS and TiO₂. These results indicate that the ZnS-coated TiO₂ nanoparticles are nanoscaled.

In addition, energy dispersive X-ray (EDX) spectroscopy analyses of the ZnS-coated TiO₂ nanoparticles reveal that the atomic percents of Zn, S and Ti are 12.50%, 9.45%, and 79.05%, respectively. It was confirmed from this result that the composition ratio of Zn/S was nearly 1:1 and the thickness ratio of ZnS/TiO₂ was 1:7.

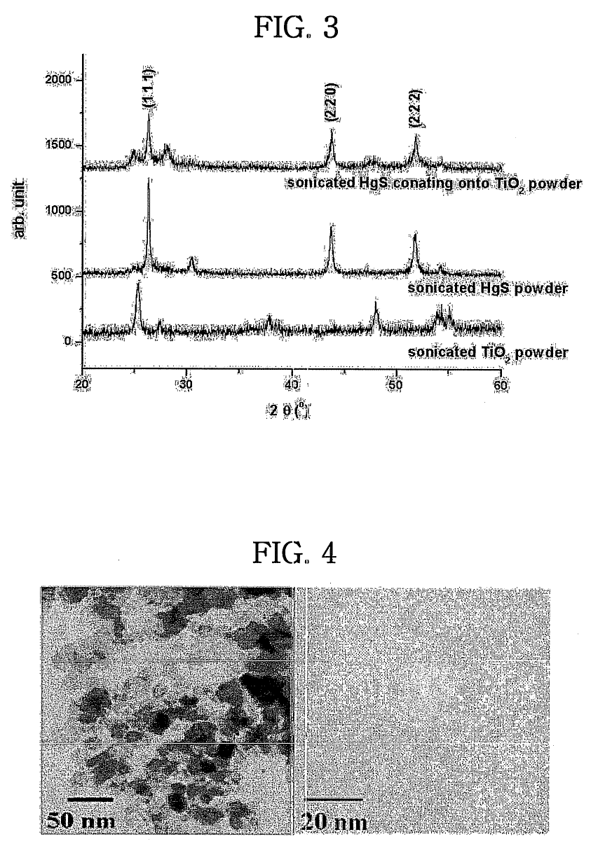

FIG. 3 shows XRD patterns of the HgS-coated TiO₂ nanoparticles prepared in Example 3. The XRD patterns indicate that HgS is in a tetragonal phase (JCPDS 1995 No. 06-0261). The positions, at which the peaks of the HgS-coated TiO₂ nanoparticles prepared under the multibubble sonoluminescence conditions are plotted, are identical to the cases of HgS and TiO₂ prior to coating. The peak thicknesses of the HgS-coated TiO₂ nanoparticles were observed to be larger than those of the CdS and TiO₂. These results indicate that the HgS-coated TiO₂ nanoparticles are nanoscaled.

In addition, energy dispersive X-ray (EDX) spectroscopy analyses of the HgS-coated TiO₂ nanoparticles reveal that the atomic percents of Hg, S and Ti are 13.59%, 8.48%, and 77.93%, respectively. It was confirmed from this result that the composition ratio of Hg/S was nearly 1:1 and the thickness ratio of HgS/TiO₂ was 1:6.

### Experimental Example 2

### Analysis of Thin Film Properties

With respect to the layered-nanoparticles prepared in Examples 1 to 3, the structures of thin films were observed using transmission electron microscopy (TEM, JEOL, JEM-2000EXII) and high resolution X-ray diffractometer (HR-TEM, JEOL, JEM-3010).

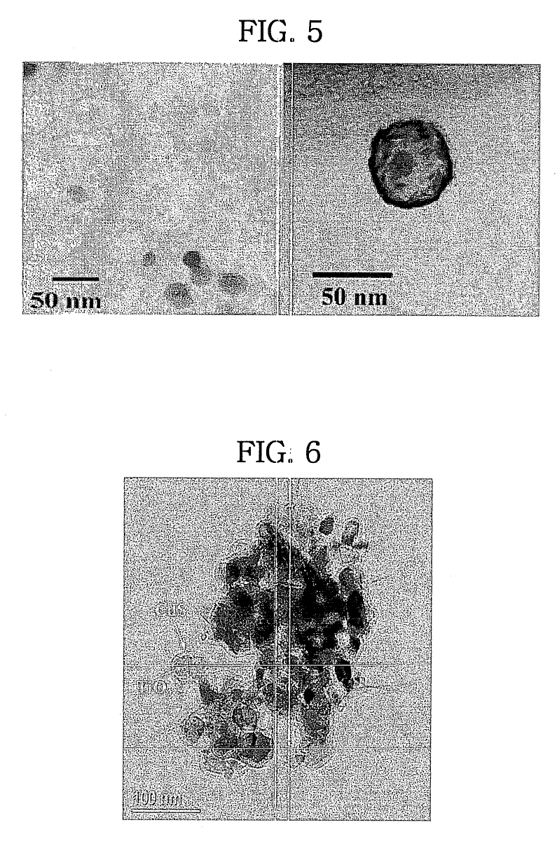

FIG. 4 is a TEM image of bare TiO₂ nanoparticles and FIG. 5 is a TEM image of the CdS-coated TiO₂ nanoparticles prepared in Example 1. These results reveal that the CdS-coated TiO₂ nanoparticles have a substantially spherical shape. The bare TiO₂ nanoparticles have an average diameter of 20 nm, whereas the CdS-coated TiO₂ nanoparticles have an average diameter of 25 to 30 nm. From these results, it was confirmed that CdS nanoparticles were uniformly coated on the TiO₂ nanoparticle surfaces.

FIG. 6 is a HR-TEM image of the CdS-coated TiO₂ nanoparticles prepared in Example 1. As can be seen from the HR-TEM image, CdS nanoparticles were uniformly coated on the TiO₂ nanoparticle surfaces.

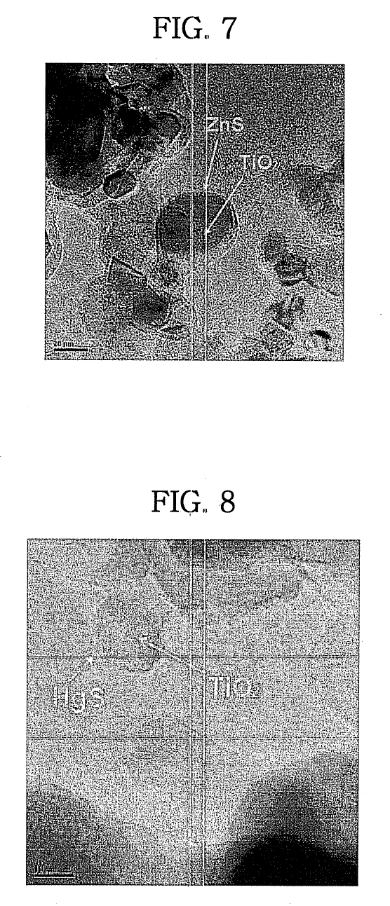

FIG. 7 is a HR-TEM image of ZnS-coated TiO₂ nanoparticles and FIG. 8 is a HR-TEM image of HgS-coated TiO₂ nanoparticles.

In a case where nanoparticles are obtained under the conditions that a reaction concentration ratio of TiO₂ to ZnS or HgS was 3:1, the ZnS or HgS was coated to a small thickness (i.e. about 2 nm) on the TiO₂ surface.

According to the method of example embodiments of the present invention, it can be confirmed that nano-materials were uniformly coated to a nano-scale thickness on the surface of nanoparticles prepared under the multibubble sonoluminescence conditions.

Although example embodiments have been disclosed for illustrative purposes, those skilled in the art will appreciate that various modifications and variations are possible, without departing from the scope and spirit of the appended claims. Accordingly, such modifications and variations are intended to come within the scope of the claims.

As apparent from the above description, the method for preparing layered nanostructures of example embodiments may include uniformly coating a nanomaterial to a desired thickness on a nano-scale support under multibubble sonoluminescence conditions. Layered nanostructures, where a nanomaterial is uniformly coated to a desired thickness on a nano-scale support, can be obtained by the method. Furthermore, the use of the method realizes reproductive preparation of uniform layered nanostructures at a relatively low temperature and rapid speed.

What is claimed is:

1. A method for preparing a layered nanostructure by coating a nanomaterial on the surface of a nano-scale support under multibubble sonoluminescence conditions.

2. The method according to claim 1, wherein the nano-scale support is a metal oxide particle with a diameter of 50 nm or less.

3. The method according to claim 2, wherein the metal oxide particle is selected from the group consisting of TiO₂, ZnO, ZrO, Al₂O₃, Fe₂O₃, Fe₃O₄, Ga₂O₃, SnO₂, Sb₂O₃, SiO₂, MnO₂, NiO₂ and a mixture thereof.

4. The method according to claim 1, wherein the nanomaterial is metal chalcogenide selected from metal sulfide, metal selenide and metal telluride.

5. The method according to claim 4, wherein the metal chalcogenide is selected from the group consisting of CdS, ZnS, HgS, PbS, InS, AgS, CuS, CdSe, ZnSe, HgSe, PbSe, InSe, AgSe, CuSe, CdTe, ZnTe, HgTe, PbTe, InTe, AgTe, CuTe and a mixture thereof.

6. The method according to claim 1, wherein the multibubble sonoluminescence conditions are obtained by maintaining a pressure of 1 to 2 atm via introduction of an inert gas into a reactor and keeping a constant temperature of 20 to 70° C. under an ultrasonic frequency of 20 kHz and a ultrasonic power of 110 to 220 W.

7. The method according to claim 6, wherein the reactor is a glass or quartz reactor.

8. The method according to claim 6, wherein the inert gas is an argon, nitrogen or helium gas.

9. The method according to claim 6, wherein the method is in situ carried out by mixing metal chloride, a chalcogen element precursor and metal oxide with a solvent in the reactor.

10. The method according to claim 9, wherein the solvent is distilled water or alcohol.

11. The method according to claim 9, wherein the method comprises sonicating the reactant mixture for 20 to 30 min after the mixing.

12. The method according to claim 9, wherein the metal chloride and the chalcogen element precursor are mixed in a reaction mole ratio of 1:1.

13. The method according to claim 9, wherein a thickness ratio of the metal chalcogenide:the metal oxide is adjusted to 1:10 to 1:5 by controlling the reaction concentration ratio of the metal chalcogenide:the metal oxide in the range of 3:1 to 5:1.

14. A layered nanostructure prepared by the method according to any one of claims 1 to 13, the layered nanostructure having a structure in which a nanomaterial is coated on the surface of a nano-scale support.

15. The layered nanostructure according to claim 14, wherein the nanomaterial is coated to a thickness of 2 to 30 nm on the surface of the nano-scale support.

16. The layered nanostructure according to claim 14, wherein the nano-scale support is a metal oxide particle.

17. The layered nanostructure according to claim 16, wherein the metal oxide particle is selected from the group consisting of TiO₂, ZnO, ZrO, Al₂O₃, Fe₂O₃, Fe₃O₄, Ga₂O₃, SnO₂, Sb₂O₃, SiO₂, MnO₂, NiO₂ and a mixture thereof.

18. The layered nanostructure according to claim 14, wherein the nanomaterial is metal chalcogenide selected from metal sulfide, metal selenide and metal telluride.

19. The layered nanostructure according to claim 18, wherein the metal chalcogenide is selected from the group consisting of CdS, ZnS, HgS, PbS, InS, AgS, CuS, CdSe, ZnSe, HgSe, PbSe, InSe, AgSe, CuSe, CdTe, ZrTe, HgTe, PbTe, InTe, AgTe, CuTe and a mixture thereof.
